(19) United States
(12) Patent Application Publication
(10) Pub. No.: US 2024/0371148 A1
(43) Pub. Date: Nov. 7, 2024

(54) LOCATION ESTIMATION DEVICE, LOCATION ESTIMATION LEARNING DEVICE, LOCATION ESTIMATION METHOD, LOCATION ESTIMATION LEARNING METHOD, LOCATION ESTIMATION PROGRAM, AND LOCATION ESTIMATION LEARNING PROGRAM

(71) Applicant: NIPPON TELEGRAPH AND TELEPHONE CORPORATION, Tokyo (JP)

(72) Inventors: Kaori KUMAGAI, Tokyo (JP); Takayuki UMEDA, Tokyo (JP); Masaki KITAHARA, Tokyo (JP); Jun SHIMAMURA, Tokyo (JP)

(73) Assignee: NIPPON TELEGRAPH AND TELEPHONE CORPORATION, Tokyo (JP)

(21) Appl. No.: 18/562,771

(22) PCT Filed: May 26, 2021
(86) PCT No.: PCT/JP2021/020058

§ 371 Date: Nov. 20, 2023

(51) Int. Cl. G06V 10/80; G06T 7/73; G06V 10/82; G06V 10/86; G06V 40/10

(52) U.S. Cl. CPC G06V 10/806; G06T 7/73; G06V 10/82; G06V 10/86; G06V 40/10; G06T 2207/20081; G06T 2207/20084; G06T 2207/30196

(57) ABSTRACT

It is possible to identify a position of a target object that is difficult to recognize.

A position estimation device includes: an information fusion unit that generates fusion information in which position information of a subject object that is an object corresponding to a subject, visual information of the subject object, and relationship information indicating a relationship with a target object paired with the subject object are fused; and an object position estimation unit that estimates a position of the target object by using an object position estimator learned in advance on the basis of the fusion information.

### TECHNICAL FIELD

The disclosed technique relates to a position estimation device, a position estimation learning device, a position estimation method, a position estimation learning method, a position estimation program, and a position estimation learning program.

### BACKGROUND ART

With the rapid spread of the Internet, many users transmit various types of information on the web by using a web service such as a social networking service (SNS). In recent years, information transmitted by users is not limited to a single modal and is increasingly uploaded as paired data of texts and visual information regarding vision, such as images. Therefore, a large amount of paired data of images and texts corresponding to the images (hereinafter, referred to as captions) can be acquired from the web.

The paired data can be expected to be used in various applications if a position of an object written in a caption can be given to an image. For example, it is possible to search for a corresponding object image on the basis of a word or search for a name of an object on the basis of an image of the object. This makes it possible to perform cross-modal information search. The paired data can also be used as learning data of an object detector that identifies a position of an object in an image. As described above, a technique for identifying a position of an object corresponding to a word in a caption can be expected to be used in many applications.

Regarding an object recognizer that identifies a position of an object corresponding to a word in a caption, it is generally necessary to prepare a large number of images in which the object is captured and training information to which the position of the object is given and learn the object recognizer by using the images and the training information. Labor for preparing object images according to an object to be recognized and giving training information costs a lot, which is problematic.

Regarding the above problem, there is a technique of estimating a position of an object in an image. Conventionally, a technique has been disclosed for identifying a position of an object written in a caption even if an image in which the object is captured and training information are insufficient.

For example, in methods disclosed in Non Patent Literatures 1, 2, and 3, a possible region of an object is estimated from an image, and an image feature extractor is learned in advance so as to reduce a distance between an image feature extracted from the object possible region and a language feature of a word. By using the image feature extractor, a matching unit associates the image feature extracted for each object possible region with the language feature of a name of the object, thereby identifying a position of the object corresponding to the name of the object.

### CITATION LIST

### Non Patent Literature

Non Patent Literature 1: Ankan Bansal, Karan Sikka, Gaurav Sharma, Rama Chellappa, Ajay Divakaran. “Zero-Shot Object Detection”, In Proc. Of ECCV2018.

Non Patent Literature 2: Zhihui Li, Lina Yao, Xiaoqin Zhang, Xianzhi Wang, Salil Kanhere, Huaxiang Zhang. “Zero-Shot Object Detection with Textual Descriptions”, In Proc. Of AAAI2019.

Non Patent Literature 3: Pengkai Zhu, Hanxiao Wang, Venkatesh Saligrama. “Don't Even Look Once: Synthesizing Features for Zero-Shot Detection”, In Proc. of CVPR2020.

Non Patent Literature 4: Karen Simonyan, Andrew Zisserman, “Very Deep Convolutional Networks for Large-Scale Image Recognition”, In Proc. of ICLR2015.

Non Patent Literature 5: Tomas Mikorov, Kai Chen, G. s. Corrado, Jeffrey Dean, “Efficient Estimation of Word Representations in Vector Space”, In Proc of workshop at ICLR2013.

### SUMMARY OF INVENTION

### Technical Problem

However, in the related arts, in a case where detection is missed in estimating a possible region of an object, a place of the object cannot be identified. For example, in a case where an object to be recognized is partially hidden as illustrated in FIG. 1, detection of a possible region of the object may fail with higher possibility. In the example of FIG. 1, a smartphone serving as a target object is hidden by a hand of a person serving as a subject object, and a possible region thereof cannot be estimated.

The disclosed technique has been made in view of the above points, and an object thereof is to provide a position estimation device, a position estimation learning device, a position estimation method, a position estimation learning method, a position estimation program, and a position estimation learning program capable of identifying a position of a target object that is difficult to recognize.

### Solution to Problem

A first aspect of the present disclosure is a position estimation device including: an information fusion unit that generates fusion information in which position information of a subject object that is an object corresponding to a subject, visual information of the subject object, and relationship information indicating a relationship with a target object paired with the subject object are fused; and an object position estimation unit that estimates a position of the target object by using an object position estimator learned in advance on the basis of the fusion information.

A second aspect of the present disclosure is a position estimation learning device including: an information fusion unit that receives, as learning data, position information of a subject object that is an object corresponding to a subject, visual information of the subject object, position information of a target object paired with the subject object, and relationship information indicating a relationship with the target object paired with the subject object, and generates fusion information in which the position information of the subject object, the visual information of the subject object, and the relationship information are fused; an object position estimation unit that estimates estimated position information by using an object position estimator on the basis of the fusion information; and a parameter update unit that calculates relative position information that is a correct answer of the position information of the subject object and the position information of the target object and updates a parameter of the object position estimator to reduce a distance between the estimated position information and the relative position information so as to optimize the position information of the target object and the calculated estimated position information.

A third aspect of the present disclosure is a position estimation method for causing a computer to execute processing including: generating fusion information in which position information of a subject object that is an object corresponding to a subject, visual information of the subject object, and relationship information indicating a relationship with a target object paired with the subject object are fused; and estimating a position of the target object by using an object position estimator learned in advance on the basis of the fusion information.

A fourth aspect of the present disclosure is a position estimation learning method for causing a computer to execute processing including: receiving, as learning data, position information of a subject object that is an object corresponding to a subject, visual information of the subject object, position information of a target object paired with the subject object, and relationship information indicating a relationship with the target object paired with the subject object; generating fusion information in which the position information of the subject object, the visual information of the subject object, and the relationship information are fused; estimating estimated position information by using an object position estimator on the basis of the fusion information; and calculating relative position information that is a correct answer of the position information of the subject object and the position information of the target object and updating a parameter of the object position estimator to reduce a distance between the estimated position information and the relative position information so as to optimize the position information of the target object and the calculated estimated position information.

A fifth aspect of the present disclosure is a position estimation program for causing a computer to execute processing including: generating fusion information in which position information of a subject object that is an object corresponding to a subject, visual information of the subject object, and relationship information indicating a relationship with a target object paired with the subject object are fused; and estimating a position of the target object by using an object position estimator learned in advance on the basis of the fusion information.

A sixth aspect of the present disclosure is a position estimation learning program for causing a computer to execute processing including: receiving, as learning data, position information of a subject object that is an object corresponding to a subject, visual information of the subject object, position information of a target object paired with the subject object, and relationship information indicating a relationship with the target object paired with the subject object; generating fusion information in which the position information of the subject object, the visual information of the subject object, and the relationship information are fused; estimating estimated position information by using an object position estimator on the basis of the fusion information; and calculating relative position information that is a correct answer of the position information of the subject object and the position information of the target object and updating a parameter of the object position estimator to reduce a distance between the estimated position information and the relative position information so as to optimize the position information of the target object and the calculated estimated position information.

### Advantageous Effects of Invention

The disclosed technique can identify a position of a target object that is difficult to recognize.

### BRIEF DESCRIPTION OF DRAWINGS

FIG. 1 illustrates an example where an object to be recognized is partially hidden in methods in the related arts.

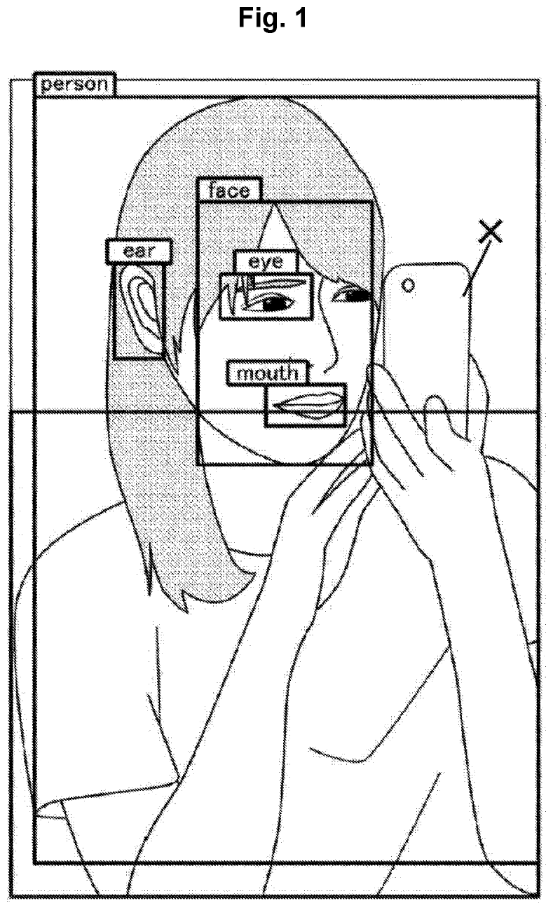

FIG. 2 illustrates an example of identifying a position of a target object by interpolating object recognition on the basis of a relationship of person-holds-smartphone.

FIG. 3 is a block diagram illustrating a hardware configuration of a position estimation learning device and a position estimation device.

FIG. 4 is a block diagram illustrating a configuration of a position estimation learning device according to the present embodiment.

FIG. 5 illustrates an example of fusion information and an example of output of estimated position information.

FIG. 6 is a block diagram illustrating a configuration of a position estimation device according to the present embodiment.

FIG. 7 is a flowchart of a flow of position estimation learning processing by a position estimation learning device.

FIG. 8 is a flowchart of a flow of position estimation processing by a position estimation device.

### DESCRIPTION OF EMBODIMENTS

Hereinafter, an exemplary embodiment of the disclosed technique will be described with reference to the drawings. In the drawings, the same or equivalent components and parts will be denoted by the same reference signs. Further, dimensional ratios in the drawings are exaggerated for convenience of description and may be different from actual ratios.

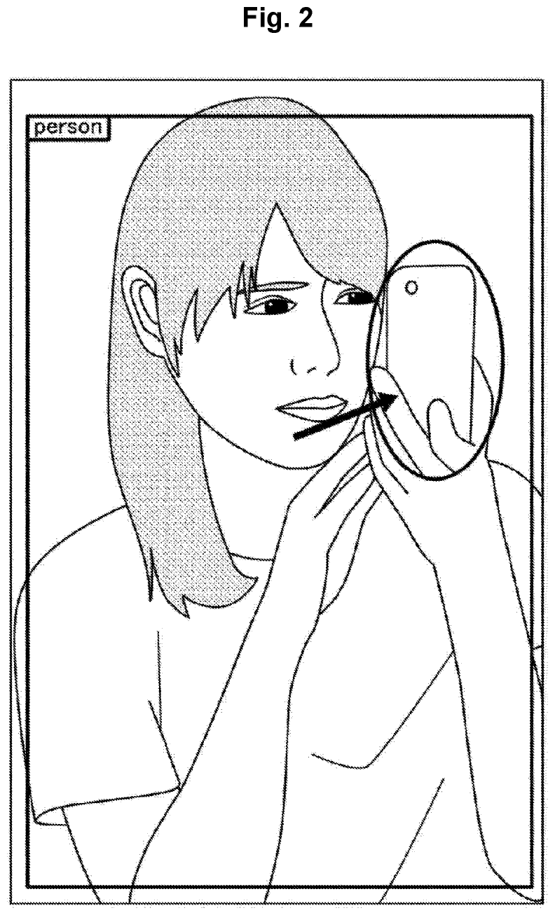

Hereinafter, a configuration of the embodiment of the present disclosure will be described. In the embodiment, <Learning Processing> of a position estimation learning device and <Inference Processing> of a position estimation device will be described. A method of the configuration according to the present disclosure identifies a position of a target object by using a relationship between a subject object and the target object. FIG. 2 illustrates an example of identifying the position of the target object by interpolating object recognition on the basis of a relationship of person-holds-smartphone. As described above, it is assumed that an object and a relationship thereof can be easily defined on the basis of a sentence generally associated with an image and common knowledge. The subject object is an object corresponding to a subject in the image, and the target object is an object paired with the subject object.

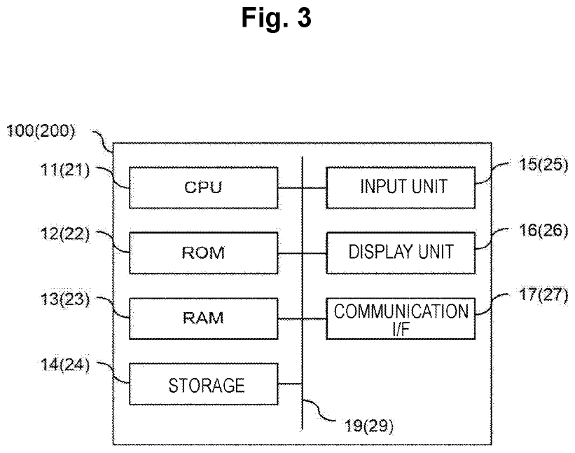

FIG. 3 is a block diagram illustrating a hardware configuration of a position estimation learning device 100 and a position estimation device 200. The position estimation learning device 100 and the position estimation device 200 can have similar hardware configurations. The position estimation learning device 100 and the position estimation device 200 may be configured as an integrated device.

As illustrated in FIG. 3, the position estimation learning device 100 includes a central processing unit (CPU) 11, a read only memory (ROM) 12, a random access memory (RAM) 13, a storage 14, an input unit 15, a display unit 16, and a communication interface (I/F) 17. The components are communicatively connected to each other via a bus 19.

The CPU 11 is a central processing unit and executes various programs and controls each unit. That is, the CPU 11 reads the programs from the ROM 12 or the storage 14 and executes the programs by using the RAM 13 as a work area. The CPU 11 controls each component described above and performs various types of calculation processing according to the programs stored in the ROM 12 or the storage 14. In the present embodiment, the ROM 12 or the storage 14 stores a model learning program.

The ROM 12 stores various programs and various types of data. The RAM 13 temporarily stores programs or data as a work area. The storage 14 includes a storage device such as a hard disk drive (HDD) or solid state drive (SSD) and stores various programs including an operating system and various types of data.

The input unit 15 includes a pointing device such as a mouse and a keyboard and is used to perform various inputs.

The display unit 16 is, for example, a liquid crystal display and displays various types of information. The display unit 16 may function as the input unit 15 by employing a touchscreen system.

The communication interface 17 is an interface for communicating with another device such as a terminal. For the communication, for example, a wired communication standard such as Ethernet (registered trademark) or FDDI or a wireless communication standard such as 4G, 5G, or Wi-Fi (registered trademark) is used.

Similarly, the position estimation device 200 includes a CPU 21, a ROM 22, a RAM 23, a storage 24, an input unit 25, a display unit 26, and a communication I/F 27. The components are communicably connected to each other via a bus 29. The ROM 22 or the storage 24 stores a position estimation program. The description of each unit of the hardware configuration is similar to that of the position estimation learning device 100 and thus will be omitted.

Next, each functional configuration of the position estimation learning device 100 will be described.

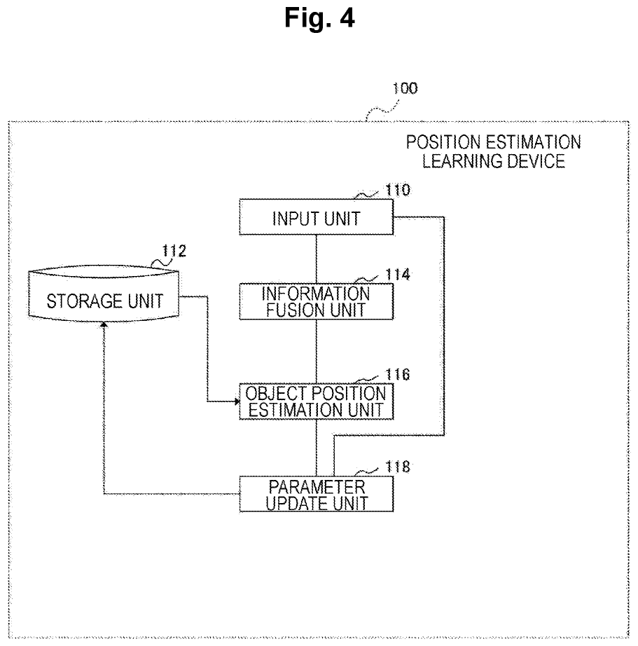

FIG. 4 is a block diagram illustrating a configuration of the position estimation learning device 100 according to the present embodiment. Each functional configuration is achieved by the CPU 11 reading a recognition program stored in the ROM 12 or the storage 14 and developing and executing the recognition program in the RAM 13.

As illustrated in FIG. 4, the position estimation learning device 100 includes an input unit 110, a storage unit 112, an information fusion unit 114, an object position estimation unit 116, and a parameter update unit 118.

The input unit 110 receives input of learning data. The learning data is one or more sets of position information of the subject object, position information of the target object, visual information of the subject object, and relationship information. Among pieces of the received learning data, the input unit 110 outputs one or more sets of the position information of the subject object, the visual information of the subject object, and the relationship information to the information fusion unit 114 and outputs the position information of the subject object and the position information of the target object to the parameter update unit 118. Each type of information will be described below.

The position information of the subject object may be any information as long as the information indicates a region of the subject object in an image. For example, when the uppermost left coordinates of the region where the subject object exists is (x′, y′), a horizontal width is w′, and a vertical width is h′, a combination of (x′, y′, w′, h′) can be used as the position information of the subject object.

The position information of the target object may be any information as long as the information indicates a region of the target object in the image. For example, when the uppermost left coordinates of the region where the target object exists is (xo, yo), the horizontal width is wo, and the vertical width is ho, a combination of (xo, yo, wo, ho) can be used as the position information of the target object.

The visual information of the subject object may be any information as long as the information indicates an image feature of the subject object. For example, a tensor output by inputting an image of the region of the subject object to a VGG network in Non Patent Literature 4 can be used. Not only the image feature of the subject object but also an image feature of a peripheral region of the subject object may be associated. For example, a tensor output by inputting the entire image to the VGG network can be used.

The relationship information may be any information as long as the information indicates a relationship between the subject object and the target object. For example, description will be made by defining a name of the subject object as a word s, a name of the target object as a word o, and the relationship as a word w. At this time, the word w may be input to the word2vec model proposed in Non Patent Literature 5, and an output vector wv may be used as the relationship information. Further, a vector sv or vector ov output by inputting the word s or word o to the word2vec model may be used as the relationship information, or an average vector of the vectors wv, sv, and ov may be used as the relationship information.

The storage unit 112 stores an object position estimator and a parameter thereof. The object position estimator is a neural network that outputs estimated position information of the target object on the basis of fusion information created by the information fusion unit 114. Any neural network that outputs the position of the target object may be used as the object position estimator.

The information fusion unit 114 creates the fusion information in which the position information of the subject object, the visual information of the subject object, and the relationship information are fused. The fusion information may be specifically any tensor as long as the tensor is created by using the visual information and the relationship information of the subject object. The position information of the subject object may or may not be used at the time of creating the fusion information.

The object position estimation unit 116 receives the fusion information from the information fusion unit 114 and receives the object position estimator and the parameter thereof from the storage unit 112. The object position estimation unit 116 estimates the estimated position information by using the object position estimator on the basis of the fusion information and outputs the estimated position information to the parameter update unit 118.

The parameter update unit 118 updates the parameter of the object position estimator so as to satisfy a constraint to optimize the position information of the target object and the calculated estimated position information. The parameter is updated by calculating relative position information that is a correct answer of the position information of the subject object and the position information of the target object so as to reduce a distance between the estimated position information and the relative position information.

The constraint for the optimization is to update the parameter of the object position estimator such that the position calculated based on the estimated position information is same as the position information of the target object, and any learning method may be used as long as the learning method is set to satisfy the constraint. For example, the relative position information that is the correct answer of the position information {xₛ, yₛ, wₛ, hₛ} of the subject object and the target object position {xₒ, yₒ, wₒ, hₒ} is calculated according to Expression (1) below, then an L1 distance between the estimated position information and the relative position information is calculated, and the parameter of the object position estimator is updated to reduce the L1 distance.

$$\begin{matrix}[ Math . 1 ] & \\ \{ \frac{{x}_{o} - {x}_{s}}{{w}_{s}} , \frac{{y}_{o} - {y}_{s}}{{h}_{s}} , log \frac{{w}_{o}}{{w}_{s}} , log \frac{{h}_{o}}{{h}_{s}} \} & ( 1 )\end{matrix}$$

As in Expression (1), the relative position information is defined by a relationship between a difference between x coordinates and a horizontal width wₛ of the subject object, a relationship between a difference between y coordinates and a vertical width hₛ of the subject object, a relationship of a ratio of the horizontal width wₛ of the subject object to a horizontal width wₒ of the target object, and a relationship of a ratio of the vertical width hₛ of the subject object to a vertical width ho of the target object.

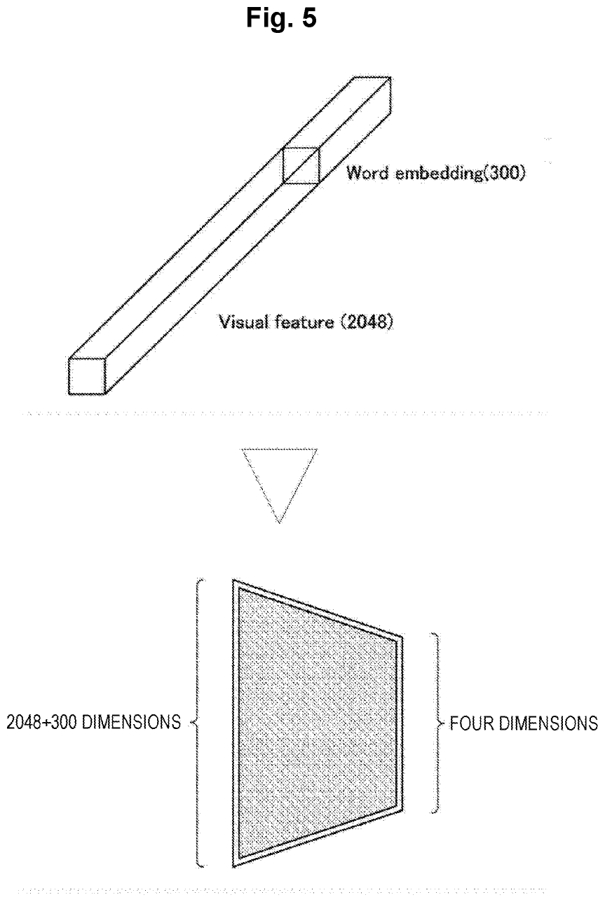

FIG. 5 illustrates an example of the fusion information and an example of output of the estimated position information. The fusion information is defined by, for example, a visual feature (2048) of the visual information of the subject object and word embedding (300) of the relationship information. The estimated position information is, for example, four-dimensional information output based on a 2048+300 dimensional input.

Next, each functional configuration of the position estimation device 200 will be described.

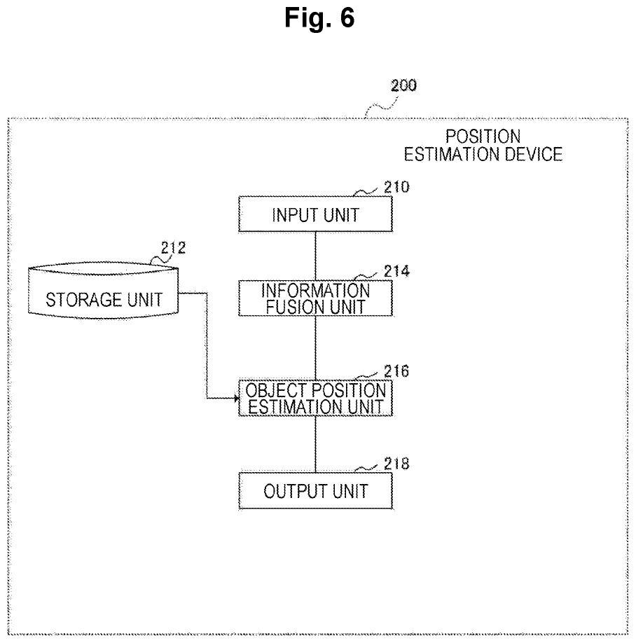

FIG. 6 is a block diagram illustrating a configuration of the position estimation device 200 according to the present embodiment. Each functional configuration is achieved by the CPU 21 reading a recognition program stored in the ROM 22 or the storage 24 and developing and executing the recognition program in the RAM 23.

As illustrated in FIG. 6, the position estimation device 200 includes an input unit 210, a storage unit 212, an information fusion unit 214, an object position estimation unit 216, and an output unit 218.

The input unit 210 receives input of inference data. The inference data is one or more sets of the position information of the subject object, the visual information of the subject object, and the relationship information. The position information of the subject object, the visual information of the subject object, and the relationship information at the time of inference are data in a format similar to that of the data at the time of learning.

The storage unit 212 stores the object position estimator and the parameter learned by the position estimation learning device 100.

The information fusion unit 214 creates fusion information in which the position information of the subject object, the visual information of the subject object, and the relationship information are fused.

The object position estimation unit 216 receives the fusion information from the information fusion unit 114 and receives the object position estimator and the parameter thereof from the storage unit 112. The object position estimation unit 116 estimates the position of the target object by using the object position estimator on the basis of the fusion information and outputs the position to the output unit 218.

The output unit 218 outputs estimated position information estimated for the target object to the outside in a predetermined format. The format may be any format as long as the format indicates the position, such as a format that identifies the estimated position in the image by using a frame or the like.

Next, operations of the position estimation learning device 100 and the position estimation device 200 will be described.

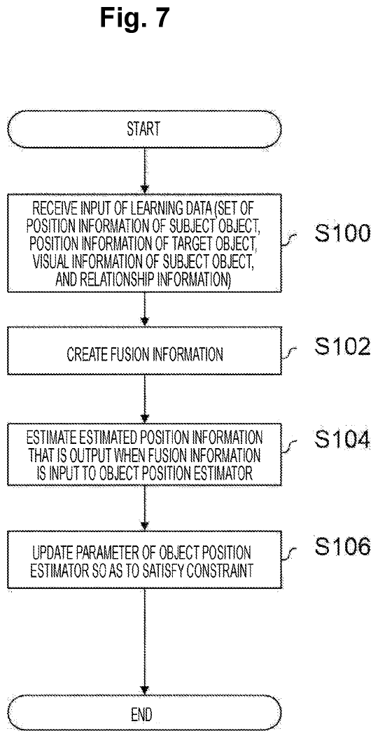

FIG. 7 is a flowchart of a flow of position estimation learning processing by the position estimation learning device 100. The CPU 11 reads a position estimation learning program from the ROM 12 or the storage 14 and develops and executes the program in the RAM 13, thereby performing the position estimation learning processing.

In step S100, the CPU 11 serving as the input unit 110 receives input of learning data. The learning data is one or more sets of position information of the subject object, position information of the target object, visual information of the subject object, and relationship information. The subsequent processing may be performed on one set at a time.

In step S102, the CPU 11 serving as the information fusion unit 114 creates fusion information in which the position information of the subject object, the visual information of the subject object, and the relationship information are fused.

In step S104, the CPU 11 serving as the object position estimation unit 116 estimates estimated position information that is an output when the fusion information is input to the object position estimator. The estimation is performed by receiving the fusion information from the information fusion unit 114 and receiving the object position estimator and a parameter thereof from the storage unit 112.

In step S106, the CPU 11 serving as the parameter update unit 118 updates the parameter of the object position estimator so as to satisfy a constraint to optimize the position information of the target object and the calculated estimated position information.

As described above, the position estimation learning device 100 of the present embodiment can learn a parameter capable of identifying a position of the target object that is difficult to recognize.

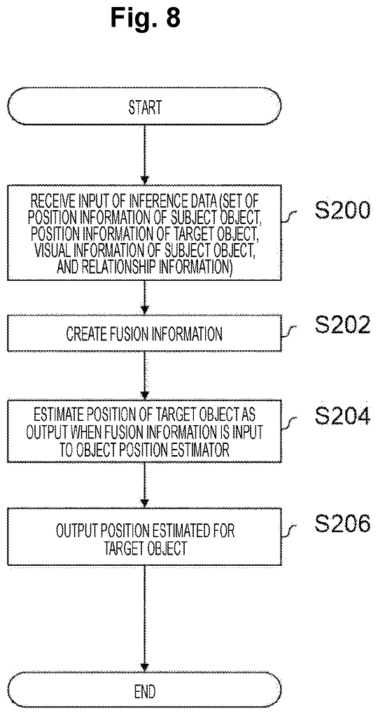

FIG. 8 is a flowchart of a flow of position estimation processing by the position estimation device 200. The CPU 21 reads the position estimation program from the ROM 22 or the storage 24 and develops and executes the position estimation program in the RAM 23, thereby performing the position estimation processing.

In step S200, the CPU 21 serving as the input unit 210 receives input of inference data. The inference data is one or more sets of position information of the subject object, position information of the target object, visual information of the subject object, and relationship information. The subsequent processing may be performed on one set at a time.

In step S202, the CPU 21 serving as the information fusion unit 214 creates fusion information in which the position information of the subject object, the visual information of the subject object, and the relationship information are fused.

In step S204, the CPU 21 serving as the object position estimation unit 216 estimates a position of the target object as an output when the fusion information is input to the object position estimator. The estimation is performed by receiving the fusion information from the information fusion unit 214 and receiving the object position estimator and a parameter thereof from the storage unit 212.

In step S206, the output unit 218 outputs the position estimated for the target object to the outside in a predetermined format.

As described above, the position estimation device 200 of the present embodiment can identify a position of the target object that is difficult to recognize.

The position estimation learning processing or position estimation processing performed by the CPU reading software (program) in the above embodiment may be performed by various processors other than the CPU. Examples of the processors in this case include a programmable logic device (PLD) whose circuit configuration can be changed after the manufacturing, such as a field-programmable gate array (FPGA), and a dedicated electric circuit that is a processor having a circuit configuration exclusively designed for executing specific processing, such as a graphics processing unit (GPU) or an application specific integrated circuit (ASIC). Alternatively, the position estimation learning processing or the position estimation processing may be performed by one of those various processors or may be performed by a combination of two or more processors of the same type or different types (for example, a plurality of FPGAs, a plurality of GPUs, and a combination of a CPU and an FPGA). More specifically, a hardware structure of the various processors is an electric circuit in which circuit elements such as semiconductor elements are combined.

In the above embodiment, a mode in which the position estimation learning program or the position estimation program is stored (installed) in advance in the storage has been described, but the present invention is not limited thereto. The program may be provided by being stored in a non-transitory storage medium such as a compact disk read only memory (CD-ROM), a digital versatile disk read only memory (DVD-ROM), and a universal serial bus (USB) memory. The program may be downloaded from an external device via a network.

Regarding the above embodiment, the following supplementary notes are further disclosed.

### Supplementary Note 1

A position estimation device including:
a memory; and
at least one processor connected to the memory, in which
the processor
generates fusion information in which position information of a subject object that is an object corresponding to a subject, visual information of the subject object, and relationship information indicating a relationship with a target object paired with the subject object are fused, and
estimates a position of the target object by using an object position estimator learned in advance on the basis of the fusion information.

### Supplementary Note 2

A non-transitory storage medium that stores a program executable by a computer to execute position estimation processing, in which
the non-transitory storage medium
generates fusion information in which position information of a subject object that is an object corresponding to a subject, visual information of the subject object, and relationship information indicating a relationship with a target object paired with the subject object are fused, and
estimates a position of the target object by using an object position estimator learned in advance on the basis of the fusion information.

### REFERENCE SIGNS LIST

100 Position estimation learning device
110 Input unit
112 Storage unit
114 Information fusion unit
116 Object position estimation unit
118 Parameter update unit
200 Position estimation device
210 Input unit
212 Storage unit
214 Information fusion unit
216 Object position estimation unit
218 Output unit

1. A position estimation device comprising a processor configured to execute operations comprising:
generating fusion information, wherein the fusion information includes, according to fusing: position information of a subject object that is an object corresponding to a subject, visual information of the subject object, and relationship information indicating a relationship with a target object paired with the subject object; and
estimating a position of the target object using an object position estimation model learned in advance on the basis of the fusion information.

2. The position estimation device according to claim 1, wherein
the relationship information uses a vector represented by using a word s, a word o, and a word w, wherein the word s indicates a name of the subject object, the word o indicates a name of the target object, and the word w indicates a relationship between the word s and the word o.

3. The position estimation device according to claim 1, wherein
the object position estimation model is learned to optimize the position information of the target object and estimated position information to be calculated by:
calculating relative position information and the position information of the target object for learning, wherein the relative position information represents a correct answer of the position information of the subject object for learning, and
updating a parameter so as to reduce a distance between the estimated position information and the relative position information.

4. A position estimation learning device comprising a processor configured to execute operations comprising:
receiving, as learning data, position information of a subject object that is an object corresponding to a subject, visual information of the subject object, position information of a target object paired with the subject object, and relationship information indicating a relationship with the target object paired with the subject object;
generating generates fusion information, wherein the fusion information includes, according to fusing, the position information of the subject object, the visual information of the subject object, and the relationship information;
estimating estimated position information by using an object position estimation model on the basis of the fusion information; and
calculating relative position information and the position information of the target object, wherein the relative position information represents a correct answer of the position information of the subject object; and
updating a parameter of the object position estimation model to reduce a distance between the estimated position information and the relative position information so as to optimize the position information of the target object and the calculated estimated position information.

5. A position estimation method comprising:
generating fusion information, wherein the fusion information includes, according to fusing, position information of a subject object that is an object corresponding to a subject, visual information of the subject object, and relationship information indicating a relationship with a target object paired with the subject object; and
estimating a position of the target object using an object position estimation model learned in advance on the basis of the fusion information.

6-8. (canceled)

9. The position estimation device according to claim 1, wherein the subject object includes a person, and the target object includes a smartphone held by the person, and the smartphone is partially hidden in the visual information of the subject object.

10. The position estimation device according to claim 1, wherein the visual information of the subject object includes a tensor output of an image input of a region of the subject object.

11. The position estimation device according to claim 1, further comprising:
displaying, based on the estimated position of the target object, position information of the target object in an image input, wherein the image input indicates at least a part of the subject object and at least a part of the target object.

12. The position estimation device according to claim 1, wherein the relationship information is based on a vector output of a word2vec model, and the word2vec model outputs the vector output based on a word input.

13. The position estimation device according to claim 1, wherein the object position estimation model uses a neural network, and the neural network outputs the position of the target object based on the fusion information.

14. The position estimation learning device according to claim 4, wherein
the relationship information uses a vector represented by using a word s, a word o, and a word w, wherein the word s indicates a name of the subject object, the word o indicates a name of the target object, and the word w indicates a relationship between the word s and the word o.

15. The position estimation learning device according to claim 4, wherein the subject object includes a person, and the target object includes a smartphone held by the person, and the smartphone is partially hidden in the visual information of the subject object.

16. The position estimation learning device according to claim 4, wherein the visual information of the subject object includes a tensor output of an image input of a region of the subject object.

17. The position estimation learning device according to claim 4, further comprising:
displaying, based on the estimated position of the target object, position information of the target object in an image input, wherein the image input indicates at least a part of the subject object and at least a part of the target object.

18. The position estimation learning device according to claim 4, wherein the object position estimation model uses a neural network, and the neural network outputs the position of the target object based on the fusion information.

19. The position estimation method according to claim 5, wherein
the object position estimation model is learned to optimize the position information of the target object and estimated position information to be calculated by:
calculating relative position information and the position information of the target object for learning, wherein the relative position information represents a correct answer of the position information of the subject object for learning, and
updating a parameter so as to reduce a distance between the estimated position information and the relative position information.

20. The position estimation method according to claim 5, wherein the subject object includes a person, and the target object includes a smartphone held by the person, and the smartphone is partially hidden in the visual information of the subject object.

21. The position estimation method according to claim 5, further comprising:
displaying, based on the estimated position of the target object, position information of the target object in an image input, wherein the image input indicates at least a part of the subject object and at least a part of the target object.

22. The position estimation method according to claim 5,
wherein the visual information of the subject object includes a tensor output of an image input of a region of the subject object, and
wherein the relationship information is based on a vector output of a word2vec model, and the word2vec model outputs the vector output based on a word input.

23. The position estimation method according to claim 5, wherein the object position estimation model uses a neural network, and the neural network outputs the position of the target object based on the fusion information.
